(19) United States
(12) Patent Application Publication
(10) Pub. No.: US 2016/0372952 A1
(43) Pub. Date: Dec. 22, 2016

(54) CHARGING SYSTEM AND MOBILE CHARGING DEVICE AND POWER SUPPLY DEVICE THEREOF

(71) Applicant: AVer Information Inc., New Taipei City (TW)

(72) Inventors: Pin-Hua CHEN, New Taipei City (TW); Jui-Hsuan CHIANG, New Taipei City (TW); Christopher Yen, New Taipei City (TW); Chi-Fa HSU, New Taipei City (TW); Chao-Hung CHANG, New Taipei City (TW)

(21) Appl. No.: 14/924,122

(22) Filed: Oct. 27, 2015

(30) Foreign Application Priority Data
Jun. 17, 2015 (TW) 104119615

(51) Int. Cl. H02J 7/00

(52) U.S. Cl. CPC H02J 7/0054; H02J 7/007; H02J 2007/0062

(57) ABSTRACT

A charging system comprises of mobile charging device and power supply device. The mobile charging device comprise of the first transmission interface, power storage module, control module, DC to AC converter, the second transmission module and the wireless transmission module. The power supply device comprises of power input port, power transmission module, transmission port, control module and communication module. The mobile charging module obtains charging power from the power supply device. And the mobile charging device transmit setting configuration to power supply device for the analysis by the back-end processing device.

### CROSS-REFERENCE TO RELATED APPLICATIONS

This non-provisional application claims priority under 35 U.S.C. §119(a) on Patent Application No. 104119615 filed in Taiwan, R.O.C on Jan. 17, 2015, the entire contents of which are hereby incorporated by reference.

### BACKGROUND

Technical Field

The present disclosure relates to a charging system, a mobile charging device, and a power supply device thereof, particularly to a charging system, a mobile charging device, and a power supply device thereof capable of providing a setting configuration to a back-end processing device for analysis.

Description of the Related Art

As the advancement of modern technology, various electronic devices are developed. For example, multimedia mobile electronic devices, such as cell phones, tablet computers, and laptops, are becoming common in our daily lives. Users can handles things or receive new information in any time and any place with the mobile electronic devices, so that the convenience of our lives is significantly improved by these devices.

However, when the mobile electronic device is not connected to the mains electricity and is supplied by the battery, due to the limitation of the battery technology, the battery capacity is limited and not affordable for user to use unlimitedly, so that the user may not satisfied with the working time of the mobile electronic device. Although there are mains electricity charging points in the public areas, but installing the mains electricity charging points needs additional wiring and destructs the original appearance of the building.

Besides, the charging points need to match the wiring of the mains electricity, so that deploying the charging points are more constrained.

### SUMMARY

A mobile charging device for charging at least one electronic device includes a first transmission interface, a power storage module, a DC to AC converter, a second transmission interface, a control module, and a wireless transmission module. The first transmission interface is pluggably electrically connected to a power supply device to receive a charging power provided by the power supply device. The power storage module is electrically connected to the first transmission interface and is for storing the charging power and selectively converting the charging power to a DC power. The DC to AC converter is electrically connected to the power storage module and is for converting the DC power to an AC power. The second transmission interface is electrically connected to the power storage module and the DC to AC converter, and is pluggably electrically connected to the at least one electronic device, and is for outputting the DC power or the AC power to the at least one electronic device. The control module is electrically connected to the power storage module, the first transmission interface, and the second transmission interface, and is for determining a setting configuration according to a status of the mobile charging device or a status of the electrically connected at least one electronic device. The wireless transmission module is electrically connected to the control module. The mobile charging device sends the setting configuration to the power supply device or a back-end processing device through the first transmission interface or the wireless transmission module selectively.

A power supply device for providing electricity to at least one mobile charging device includes a case, a power input port, a power conversion module, a plurality of transmission ports, a control module, and a communication module. The case has a plurality of slots, and each of the plurality of slots is for containing one of the mobile charging devices. The power input port is for receiving a mains electricity. The power conversion module is electrically connected to the power input port and is for converting the mains electricity to a charging power. The plurality of transmission ports are electrically connected to the power conversion module, and each of the plurality of transmission ports is in one of the slots and is pluggably electrically connected to one of the mobile charging devices, and is for providing the charging power to the at least one mobile charging device. The control module is electrically connected to the power input port and to the plurality of transmission ports. The communication module is electrically connected to the control module and communication connected to the at least one mobile charging device or a back-end processing device. The power supply device sends a setting configuration to the mobile charging device through the plurality of transmission ports or the communication module selectively.

A charging system includes at least one mobile charging device and a power supply device. The at least one mobile charging device is for charging at least one electronic device, and each of the mobile charging devices includes a first transmission interface, a power storage module, a DC to AC converter, a second transmission interface, a first control module, and a wireless transmission module. The first transmission interface is for receiving a charging power. The power storage module is electrically connected to the first transmission interface, and is for storing the charging power and selectively converting the charging power to a DC power. The DC to AC converter is electrically connected to the power storage module, and is for converting the DC power to a AC power. The second transmission interface is electrically connected to the power storage module and the DC to AC converter, and is pluggably electrically connected to the at least one electronic device, and is for outputting the DC power or the AC power to the at least one electronic device. The first control module is electrically connected to the power storage module, the first transmission interface, and the second transmission interface, and is for determining a setting configuration according to a status of the mobile charging device or a status of the electrically connected at least one electronic device. The wireless transmission module is electrically connected to the first control module. The mobile charging device sends the setting configuration to the power supply device or a back-end processing device through the first transmission interface or the wireless transmission module selectively. The power supply device includes a case, a power input port, a power conversion module, a plurality of transmission ports, a second control module, and a communication module. The case has a plurality of slots, and each of the plurality of slots is for containing one of the mobile charging devices. The power input port is for receiving a mains electricity. The power conversion module is electrically connected to the power input port, and is for converting the mains electricity to a charging power. The plurality of transmission ports are electrically connected to the power conversion module, and each of the plurality of transmission ports is in one of the slots and is pluggably electrically connected to one of the mobile charging devices, and is for providing the charging power to the at least one mobile charging device. The second control module is electrically connected to the power input port and to the plurality of transmission ports. The communication module is electrically connected to the second control module and communication connected to the at least one mobile charging device or a back-end processing device. The power supply device sends a setting configuration to the mobile charging device through the plurality of transmission ports or the communication module selectively. The contents of the present disclosure set forth and the embodiments hereinafter are for demonstrating and illustrating the spirit and principles of the present disclosure, and for providing further explanation of the claims.

### BRIEF DESCRIPTION OF THE DRAWINGS

The present disclosure will become more fully understood from the detailed description given hereinbelow and the accompanying drawings, which are given by way of illustration only and thus are not limitative of the present disclosure and wherein:

FIG. 1 is a functional block diagram of the mobile charging device according to an embodiment;

FIG. 2A is an isometric diagram of the mobile charging device in a first angle of view according to an embodiment;

FIG. 2B is an isometric diagram of the mobile charging device in a second angle of view according to FIG. 2A;

FIG. 3 is a functional block diagram of the power supply device according to an embodiment;

FIG. 4 is an isometric diagram of the power supply device according to an embodiment;

and

FIG. 5 is a functional block diagram of the power supply device according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The figures in the embodiments are simplified diagrams for illustrating the basic structures of the present disclosure. Therefore, the components shown in the figures are not illustrated in practical numbers, shapes, sizes, and ratios. The practical size is actually a selective design and the implementation of the components is possibly more complicated.

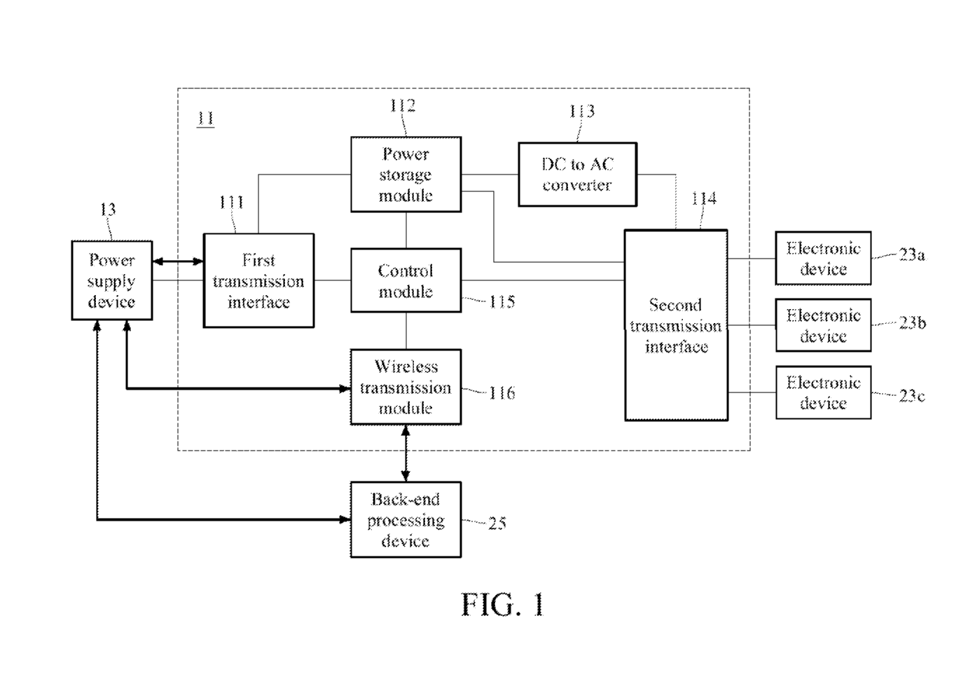

Please refer to FIG. 1. FIG. 1 is a functional block diagram of the mobile charging device according to an embodiment. As shown in FIG. 1, the mobile charging device 11 of the present disclosure includes a first transmission interface 111, a power storage module 112, a direct current (DC) to alternating current (AC) converter 113, a second transmission interface 114, a control module 115, and a wireless transmission module 116. The solid lines with arrows represent the electrical connections between blocks and the solid lines with arrows represent communication connections between blocks.

The first transmission interface 111 pluggably electrically connected to the power supply device 13 to receive the charging power provided by the power supply device 13.

The first transmission interface 111 includes, but not limited to, a connection port with POGO pins. The charging power is an AC or a DC.

The power storage module 112 is electrically connected to the first transmission interface 111 and is for storing the charging power and selectively converting the charging power to the DC power. The power storage module 112 is a single rechargeable battery or a battery set formed by a plurality of rechargeable batteries through series connection or parallel connection. Even the power storage module 112 further includes a charging module for precisely controlling the charging or discharging of the battery or battery set.

For example, when the charging power is a DC, the power storage module 112 includes a DC-DC converter and a rechargeable battery to store the charging power. In the present embodiment, the DC-DC converter is electrically connected to the rechargeable battery. When the power storage module 112 receives the charging power, the power storage module 112 firstly adjusts the voltage of the charging power to an acceptable range for the rechargeable battery by the DC-DC converter, and further charges the rechargeable battery with the adjusted charging power. When the charging power is an AC, the power storage module 112 further includes a rectifying module to convert the AC to the DC and to store the charging power as the aforementioned explanation.

The DC to AC converter 113 is electrically connected to the power storage module 112 and is for converting the DC power to the AC power. The second transmission interface 114 is electrically connected to the power storage module 112 and the DC to AC converter 113, and is pluggably electrically connected to the electronic devices 23a˜23c. The number of the electronic devices 23a˜23c is for illustrating but not for limiting the present disclosure. The second transmission interface 114 is for outputting the DC power or the AC power to the electronic devices 23a˜23c. In practice, the electronic devices 23a˜23c are specifically classified to the first electronic devices which are charged with the AC power and the second electronic devices which are charged with the DC power. The second transmission interface 114 further includes at least one AC transmission port and at least one DC transmission port. The AC transmission port is for pluggably electrically connected to the first electronic device to provide the AC power to the first electronic device. The DC transmission port is for pluggably electrically connected to the second electronic device to provide the DC power to the second electronic device.

The control module 115 is electrically connected to the power storage module 112, the first transmission interface 111, and the second transmission interface 114. The control module 115 is for determining the setting configuration according to the status of the mobile charging device 11 or the statuses of the electrically connected electronic devices 23a˜23c. The control module 115 is, but not limited to, the related integrated circuit (IC) having micro control unit (MCU) and Internet of Things (IOT). The setting configuration is related to at least one of the stored power of the power storage module 112, the usage time of the mobile charging device 11, the temperature of the mobile charging device 11, the specification of the electronic devices 23a˜23c, and the remaining power of the electronic devices 23a˜23c.

The wireless transmission module 116 is electrically connected to the control module 115, and the wireless transmission module 116 is, for example, the antenna operating in different frequencies for performing wireless communication. The mobile charging device 11 is communication connected to the power supply device 13 or the back-end processing device 25 through the first transmission interface 111 or the wireless transmission module 116 selectively, and sends the setting configuration to the power supply device 13 or the back-end processing device 25. In practice, the back-end processing device 25 is a remote server or a mobile device, such as a smart phone or a tablet. The embodiment is for illustrating but not for limiting the present disclosure.

The number of the transmission ports in the second transmission interface 114 is not limited in the present embodiment, and persons skilled in the art can design the reasonable number of the transmission ports according to the practical needs.

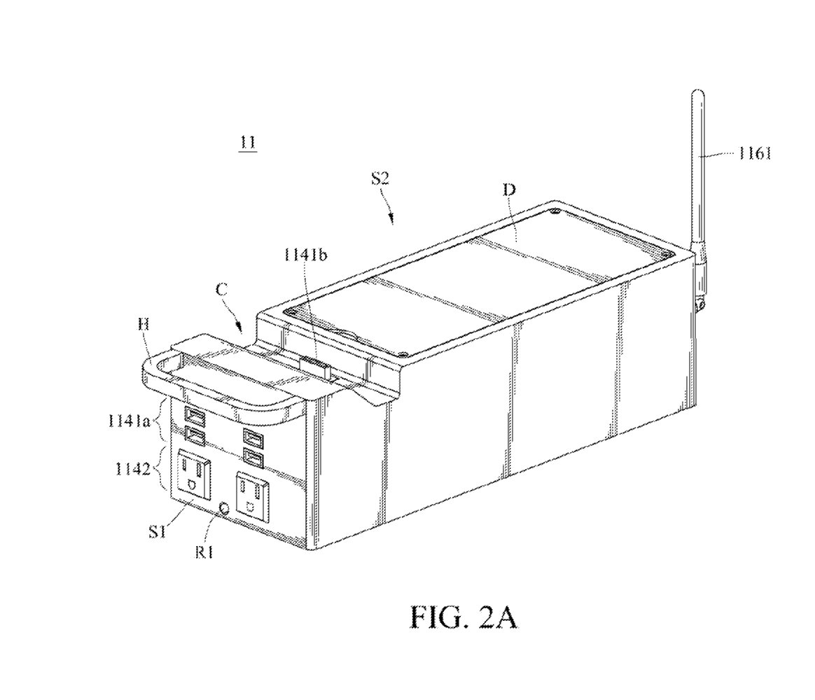

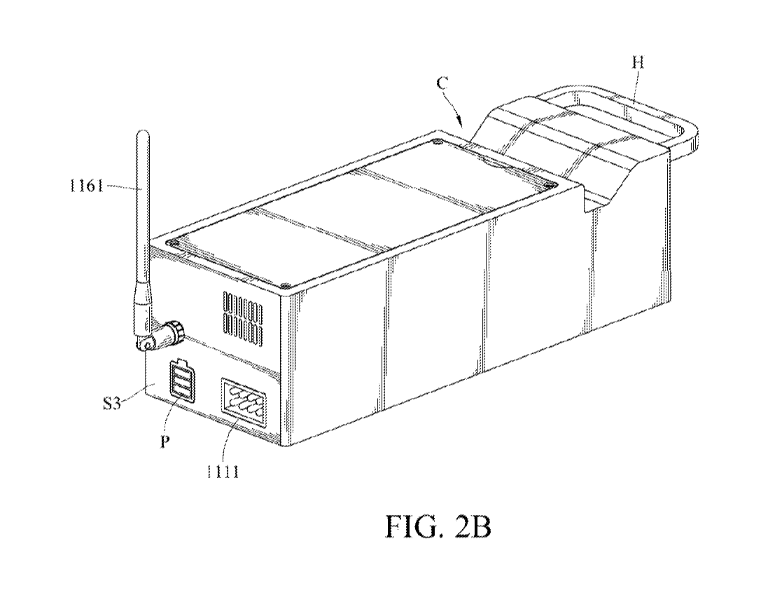

Please refer to FIG. 2A and 2B for explaining the outer structure of the mobile charging device. FIG. 2A is an isometric diagram of the mobile charging device in a first angle of view according to an embodiment. FIG. 2B is an isometric diagram of the mobile charging device in a second angle of view according to FIG. 2A. In the present embodiment, the mobile charging device 11 is actually a cuboid. A handle H, a DC transmission port 1141a, an AC transmission port 1142, and a reset button R1 are in the first surface S1. A groove C is in the second surface S2 of the mobile charging device 11 and a DC transmission port 1141b is in the groove C. When one of the electronic devices 23a˜23c is electrically connected to the DC transmission port 1141b, the groove C is for containing part of the body of the electronic device. The second surface S2 further includes a removable cover D and the cover D is for covering the power storage module 112. The DC transmission port 1141a, 1141b, and the AC transmission port 1142 are included in the second transmission interface 114.

As shown in FIG. 2B, an antenna 1161, a power notification module P, and a transmission port 1111 are in the third surface S3. The transmission port 1111 is included in the first transmission interface 111 and the antenna 1161 is included in the wireless transmission module 116. The antenna 1161 has a rotatable base and a bending part for adjustment, so that the antenna 1161 is directed to the better signal receiving location. The power notification module P is for displaying the remaining power of the power storage module 112.

The mobile charging device 11 is disclosed in the previous embodiments. The power supply device 13 is disclosed in the following embodiments.

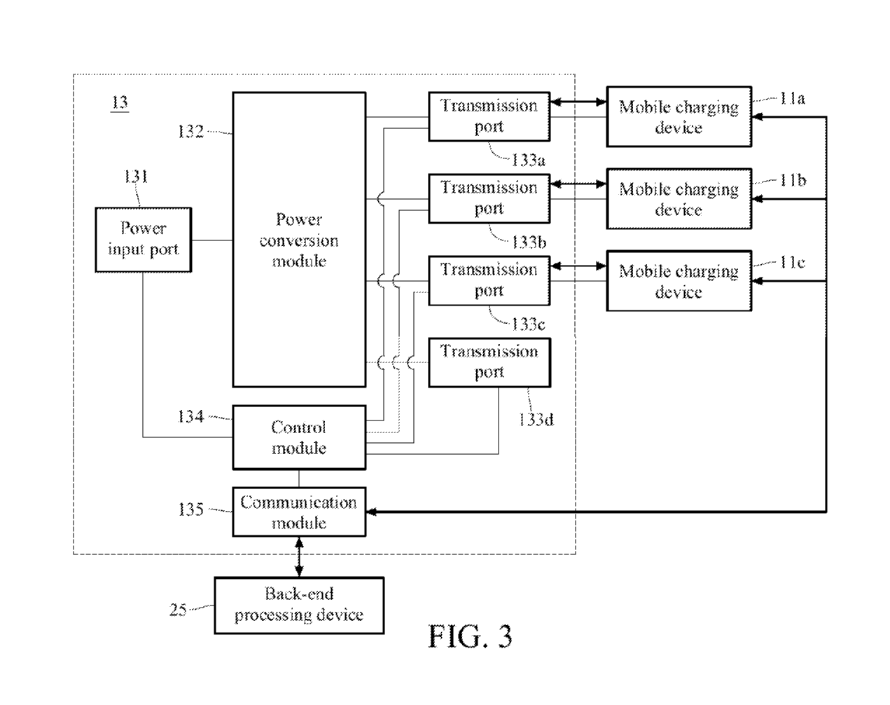

Please refer to FIG. 3. FIG. 3 is a functional block diagram of the power supply device according to an embodiment. The power supply device 13 is for supplying electricity to a plurality of mobile charging devices 11a˜11c, and each of the plurality of mobile charging devices 11a˜11c is, for example, the mobile charging device 11 the shown in the FIG. 1. The power supply device 13 includes a case 139, a power input port 131, transmission ports 133a˜133d, a control module 115, and a communication module 135. The case 139 has a plurality of slots 138a˜138d and each of the plurality of slots 138a˜138d is for containing a mobile charging device 11.

The power input port 131 is for receiving the mains electricity. The power conversion module 132 is electrically connected to the power input port 131 to convert the mains electricity to the charging power. The charging power is a DC and the power conversion module 132 adjusts the mains electricity to the charging power with different voltage levels according to the needs.

The transmission ports 133a˜133d are electrically connected to the power conversion module 132 and each of the transmission ports 133a˜133d is in one of the slots 138a˜138d. Each of the transmission ports 133a˜133d is pluggably electrically connected to one of the mobile charging device 11. As shown in the figure, the transmission ports 133a˜133d are electrically connected to the mobile charging device 11a, and the transmission port 133b is electrically connected to the mobile charging device 11b, and the transmission port 133c is electrically connected to the mobile charging device 11c. The transmission ports 133a˜133d are for providing the charging power to the electrically connected mobile charging devices 11a˜11d.

The control module 134 is electrically connected to the power input port 131 and the transmission ports 133a˜133d. The control module 134 includes, but not limited to, the related integrated circuit (IC) having micro control unit (MCU) and Internet of Things (IOT).

The communication module 135 is electrically connected to the control module 115 and is communication connected to the mobile charging device 11 or the back-end processing device 25. More specifically, the communication module 135 includes the wired connection port or the antenna, so that the communication module 135 is communication connected to the mobile charging device 11 or the back-end processing device 25 through wires or wirelessly. The wired connection port is, for example, the RJ45 Internet port. Furthermore, the power supply device 13 sends the setting configuration to the mobile charging device 11 through the transmission ports 133a˜133d or the communication module 135 selectively, or the power supply device 13 sends the setting configuration through the communication module 135 or the back-end processing device 25 selectively.

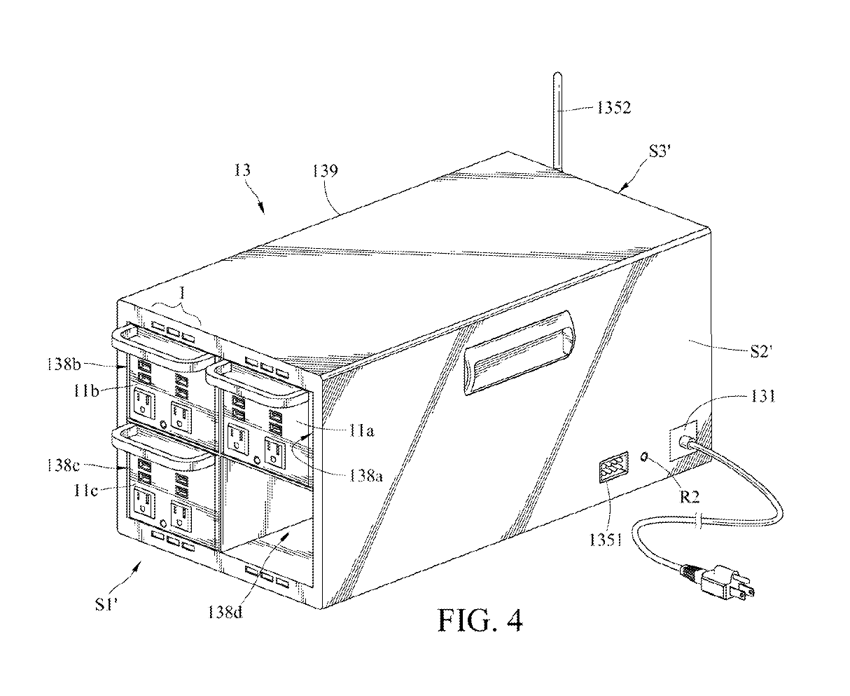

Please refer to FIG. 4. FIG. 4 is an isometric diagram of the power supply device according to an embodiment. As shown in FIG. 4, the case 139 of the power supply device 13 forms a plurality of slots 138a˜138d, and the openings of the plurality of slots 138a˜138d form the first surface S1′. The transmission ports 133a˜133d are on the bottoms of the plurality of slots 138a˜138d, so that when the mobile charging device 11 is in one of the plurality of slots 138a˜138d, the transmission port 1111 is electrically connected to the corresponding transmission port in the plurality of transmission ports 133a˜133d. The first surface S1′ further has an instructing module I for indicating the status of the mobile charging device 11 in the plurality of slots 138a˜138d. The second surface S2′ of the power supply device 13 has an information transmission port 1351, a reset button R2, and a power input port 131. The third surface S3′ of the power supply device 13 has an antenna 1352. The antenna 1352 and the information transmission port 1351 are included in the communication module 135.

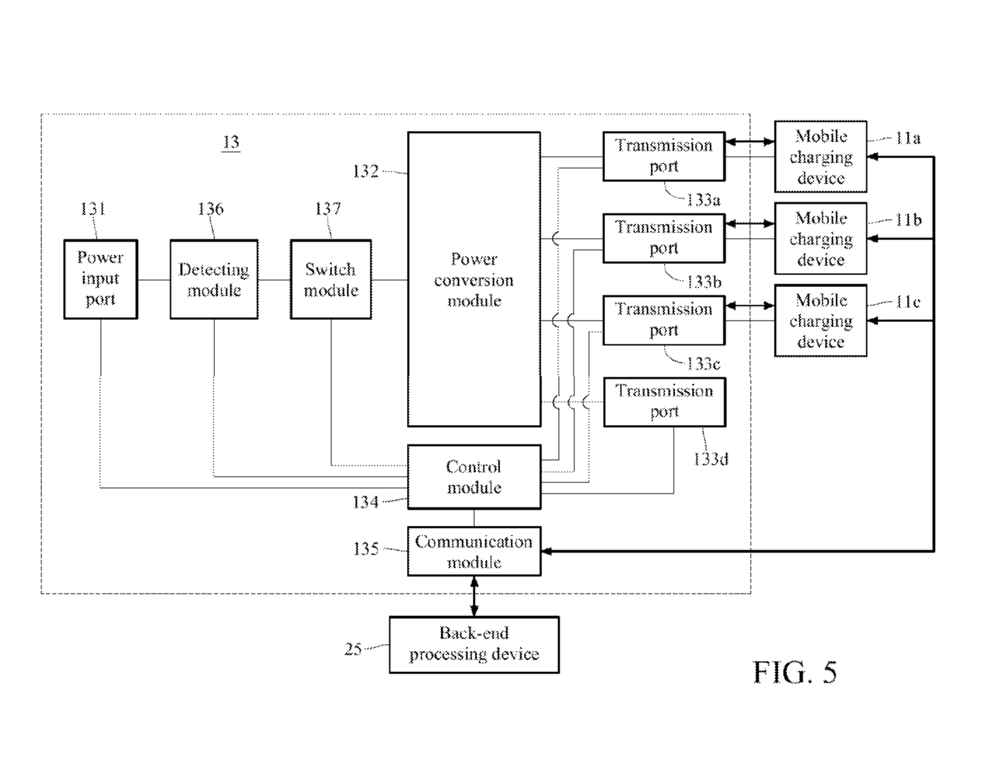

In practice, the power supply device 13 of the present disclosure further includes other functional modules for more implementations. Please refer to FIG. 5. FIG. 5 is a functional block diagram of the power supply device according to another embodiment. As shown in FIG. 5, the power supply device 13 further includes a detecting module 136 and a switch module 137. The detecting module 136 is electrically connected between the switch module 137 and the power output port, and the switch module 137 is electrically connected between the detecting module 136 and the power conversion module 132. The detecting module 136 and the switch module 137 are further electrically connected to the control module 134 respectively.

The switch module 137 is for selectively conducting electricity according to the instruction of the control module 134 to selectively transfer mains electricity to the power conversion module 132. The detecting module 136 is for detecting the amount of the total current for charging the mobile charging devices 11a˜11d, and the control module 134 selectively conducts the switch module 137 according to the amount of the total current. In practice, the switch module 137 further includes a plurality of switch units, and the power conversion module 132 further includes a plurality of power conversion units. The number of the plurality of switch units and the number of the plurality of power conversion units are the same as the number of the plurality of transmission ports. Each of the plurality of switch units is electrically connected to one of the plurality of power conversion units, and each of the plurality of power conversion units is electrically connected to one of the plurality of transmission ports.

The above explanation is for describing the functions of the mobile charging device 11 and the power supply device 13. The actuations of the mobile charging device 11 and the power supply device 13 are explained as follows.

Please refer to FIG. 1 again. As the aforementioned explanation, the mobile charging device 11 provides the charging power to the electronic devices 23a˜23c. In the first embodiment, the charging power is stored in the power storage module 112 in advance, so that the user uses the mobile charging device 11 flexibly to charge the electronic devices 23a˜23c in any place. In the second embodiment, the mobile charging device 11 is electrically connected between the power supply device 13 and the electronic devices 23a˜23c simultaneously, so that the charging power provided by the power supply device 13 is instantly rectified, transformed, and provided to the electronic devices 23a˜23c.

The first embodiment is taken as an example for the following explanation. The mobile charging device 11 is electrically connected to the power supply device 13 through the first transmission interface 111 to obtain the mains electricity provided by the power supply device 13. Next, the charging power is stored in the power storage module 112, and the power storage module 112 further includes more functional sub units to rectify or transform the charging power to produce a needed DC power as the aforementioned explanation. Next, the DC to AC converter 113 converts the DC power to the AC power, so that the mobile charging device 11 supports more charging specifications. The mobile charging device 11 is electrically connected to the electronic devices 23a˜23c through the second transmission interface 114, and provides the DC power and AC power to the electronic devices 23a˜23c through the second transmission interface 114.

In practice, the mobile charging device 11 performs charging and discharging according to the setting configuration. Therefore, except charging, the mobile charging device 11 further sends the setting configuration to the back-end processing device 25 for analysis through the wireless transmission module 116. The mobile charging device 11 is directly communication connected to the back-end processing device 25, or the mobile charging device 11 indirectly sends the setting configuration to the back-end processing device 25 through the power supply device 13.

More specifically, the mobile charging device 11 is electrically connected to the power supply device 13 through the connection port with POGO pins in the first transmission interface 111, so that the mobile charging device 11 sends the setting configuration to the power supply device 13 through the first transmission interface 111 during the process of obtaining the charging power. When the mobile charging device 11 is electrically connected to the power supply device 13 without passing the first transmission interface 111, the mobile charging device 11 is communication connected to the power supply device 13 through the wireless transmission module 116 to send the setting configuration to the power supply device 13. In other words, the back-end processing device 25 directly or indirectly adjusts the setting configuration of the mobile charging device 11 through the power supply device 13 to optimize the charging efficiency of the mobile power.

The actuations of the power supply device 13 are explained as follows. Please refer to FIG. 3 again. As shown in FIG. 3, the power supply device 13 obtains the mains electricity from the power input port 131, and the power supply device 13 performs rectification and transformation to the mains electricity to form the charging power through the power conversion module 132 and outputs the charging power to the mobile charging devices 11a˜11c for charging through the transmission ports 133a-133d.

Please refer to FIG. 5 again for explanation. In the embodiment of FIG. 5, the power supply device 13 further detects an amount of the total current with the detecting module 136, and the total current is the aggregation of the needed current provided by the power supply device 13 for charging each of the mobile charging devices 11a-11c. The detecting module 136 generates a corresponding detecting result accordingly. The control module 134 controls the conduction of the switch module 137 according to the detecting result. When the total charging current is greater than a threshold, the control module 134 controls the inner circuit of the switch module 137 to provided the charging power to only part of the transmission ports, or the control module 134 controls the inner circuit of the switch module 137 to evenly provide the charging currents to the mobile charging devices 11a˜11c instead of directly providing the needed charging currents to each of the mobile charging devices 11a˜11c.

As shown in FIG. 3 and FIG. 5, the power supply device 13 sends the setting configuration to the mobile charging devices 11a˜11c through the transmission port and the communication module 135. More specifically, the power supply device 13 is electrically connected to the mobile charging devices 11a˜11c through the connection port with POGO pins, so that the power supply device 13 simultaneously sends the setting configuration to the mobile charging device 11 through the transmission port while charging. When the power supply device 13 is not connected to the mobile charging devices 11a-11c though the transmission ports, the power supply device 13 is communication connected to the mobile charging module through the communication module 135 to send the setting configuration to the mobile charging modules 11a-11c through the Internet wire or antenna. On the other hand, the power supply device 13 further sends the setting configuration through the communication module 135 and the back-end processing device 25.

In practice, the mobile charging device 11 and the power supply device 13 of the present disclosure form a charging system. The mobile charging device 11 not only obtains the charging power from the power supply device 13, but also sends the setting configuration to the power supply device 13 by the aforementioned communication method, and the power supply device 13 further provides the setting configuration to the back-end processing device 25 for analysis. The back-end processing device 25 analyzes the setting configurations of a plurality of mobile charging devices 11 to determine the usage of the plurality of mobile charging devices 11 for the user to deploy the plurality of mobile charging devices 11 more efficiently.

A charging system, a mobile charging device, and a power supply device thereof are provided in the present disclosure. By widely installing the mobile charging device in the public areas and increasing the density of charging points, the user is able to obtain the charging service conveniently. On the other hand, by the communication between the power supply device and the mobile charging device related to the configuration, the back-end processing device analyzes the setting configuration of the mobile charging device. Accordingly, the user understands the usage of the mobile charging devices in different charging points and adjusts the deployment of the charging points correspondingly to use the mobile charging device more efficiently.

The foregoing description has been presented for purposes of illustration. It is not exhaustive and does not limit the disclosure to the precise forms or embodiments disclosed. Modifications and adaptations will be apparent to those skilled in the art from consideration of the specification and practice of the disclosed embodiments of the disclosure. It is intended, therefore, that the specification and examples be considered as exemplary only, with a true scope and spirit of the disclosure being indicated by the following claims and their full scope of equivalents.

What is claimed is:

1. A mobile charging device for charging at least one electronic device, comprising:
a first transmission interface pluggably electrically connected to a power supply device to receive a charging power provided by the power supply device;
a power storage module electrically connected to the first transmission interface, for storing the charging power and selectively converting the charging power to a direct current (DC) power;
a DC to alternating current (AC) converter electrically connected to the power storage module, for converting the DC power to an AC power;
a second transmission interface electrically connected to the power storage module and the DC to AC converter, and pluggably electrically connected to the at least one electronic device, for outputting the DC power or the AC power to the at least one electronic device;
a control module electrically connected to the power storage module, the first transmission interface, and the second transmission interface, for determining a setting configuration according to a status of the mobile charging device or a status of the electrically connected at least one electronic device; and
a wireless transmission module electrically connected to the control module;
wherein the mobile charging device sends the setting configuration to the power supply device or a back-end processing device through the first transmission interface or the wireless transmission module selectively.

2. The mobile charging device of claim 1, wherein the setting configuration is in association with at least one of a stored power of the power storage module, a usage time of the mobile charging device, a temperature of the mobile charging device, a specification of the at least one electronic device, and a remaining power of the at least one electronic device.

3. The mobile charging device of claim 1, wherein the second transmission interface further comprises:
at least one AC transmission port, each of the AC transmission ports pluggably electrically connected to a first electronic device, for providing the AC power to the first electronic device; and
at least one DC transmission port, each of the DC transmission ports pluggably electrically connected to a second electronic device, for providing the DC power to the second electronic device.

4. The mobile charging device of claim 3, wherein a surface of a case of the mobile charging device has a groove, and the DC transmission port is in the groove, and the groove is for containing part of a body of the second electronic device electrically connected to the DC transmission port.

5. A power supply device for providing electricity to at least one mobile charging device, comprising:
a case having a plurality of slots, each of the plurality of slots for containing one of the mobile charging devices;
a power input port for receiving a mains electricity;
a power conversion module electrically connected to the power input port, for converting the mains electricity to a charging power;
a plurality of transmission ports electrically connected to the power conversion module, each of the plurality of transmission ports in one of the slots and pluggably electrically connected to one of the mobile charging devices, for providing the charging power to the at least one mobile charging device;
a control module electrically connected to the power input port and to the plurality of transmission ports; and
a communication module electrically connected to the control module and communication connected to the at least one mobile charging device or a back-end processing device;
wherein the power supply device sends a setting configuration to the mobile charging device through the plurality of transmission ports or the communication module selectively.

6. The power supply device of claim 5, wherein the setting configuration is in association with at least one of a stored power of the power storage module, a usage time of the mobile charging device, a temperature of the mobile charging device, a specification of the at least one electronic device, and a remaining power of the at least one electronic device.

7. The power supply device of claim 5, further comprising a switch module electrically connected to the control module and the power conversion module, wherein the switch module is for selectively conducting according to indications of the control module to transferring the mains electricity to the power conversion module selectively.

8. The power supply device of claim 7, further comprising a detecting module electrically connected to the power input port, the control module, and the switch module, wherein the detecting module is for detecting an amount of total current for charging the at least one mobile charging device, and the control module selectively conducts the switch module according to the amount of total current.

9. A charging system, comprising:
at least one mobile charging device for charging at least one electronic device, each of the mobile charging devices comprising:
a first transmission interface for receiving a charging power;
a power storage module electrically connected to the first transmission interface, for storing the charging power and selectively converting the charging power to a DC power
a DC to AC converter electrically connected to the power storage module, for converting the DC power to a AC power;
a second transmission interface electrically connected to the power storage module and the DC to AC converter, and pluggably electrically connected to the at least one electronic device, for outputting the DC power or the AC power to the at least one electronic device;
a first control module electrically connected to the power storage module, the first transmission interface, and the second transmission interface, for determining a setting configuration according to a status of the mobile charging device or a status of the electrically connected at least one electronic device; and
a wireless transmission module electrically connected to the first control module;
wherein the mobile charging device sends the setting configuration to the power supply device or a back-end processing device through the first transmission interface or the wireless transmission module selectively; and
a power supply device, comprising:
a case having a plurality of slots, each of the plurality of slots for containing one of the mobile charging devices;
a power input port for receiving a mains electricity;
a power conversion module electrically connected to the power input port, for converting the mains electricity to a charging power;
a plurality of transmission ports electrically connected to the power conversion module, each of the plurality of transmission ports in one of the slots and pluggably electrically connected to one of the mobile charging devices, for providing the charging power to the at least one mobile charging device;
a second control module electrically connected to the power input port and to the plurality of transmission ports; and
a communication module electrically connected to the second control module and communication connected to the at least one mobile charging device or a back-end processing device;
wherein the power supply device sends a setting configuration to the mobile charging device through the plurality of transmission ports or the communication module selectively.

10. The charging system of claim 9, wherein the setting configuration is in association with at least one of a stored power of the power storage module, a usage time of the mobile charging device, a temperature of the mobile charging device, a specification of the at least one electronic device, and a remaining power of the at least one electronic device.

11. The charging system of claim 9, wherein the second transmission interface further comprises:
at least one AC transmission port, each of the AC transmission ports pluggably electrically connected to a first electronic device, for providing the AC power to the first electronic device; and
at least one DC transmission port, each of the DC transmission ports pluggably electrically connected to a second electronic device, for providing the DC power to the second electronic device.

12. The charging system of claim 11, wherein a surface of a case of the mobile charging device has a groove, and the DC transmission port is in the groove, and the groove is for containing part of a body of the second electronic device electrically connected to the DC transmission port.

13. The charging system of claim 9, further comprising a switch module electrically connected to the second control module and the power conversion module, wherein the switch module is for selectively conducting according to indications of the second control module to transferring the mains electricity to the power conversion module selectively.

14. The charging system of claim 13, further comprising a detecting module electrically connected to the power input port, the second control module, and the switch module, wherein the detecting module is for detecting an amount of total current for charging the at least one mobile charging device, and the second control module selectively conducts the switch module according to the amount of total current.
